(19) United States
(12) Patent Application Publication
(10) Pub. No.: US 2026/0346864 A1
(43) Pub. Date: Nov. 5, 2026

(54) MEMORY-BASED SYSTEM AND METHOD FOR VEHICLE ENVIRONMENTAL MAP UPDATES

(71) Applicant: GM Global Technology Operations LLC, Detroit, MI (US)

(72) Inventors: Alireza Esna Ashari Esfahani, San Bruno, CA (US); Michael Turski, Rochester, MN (US)

(21) Appl. No.: 19/197,221

(22) Filed: May 2, 2025

(51) Int. Cl. B60W 60/00; B60W 50/00; G01C 21/00; G06V 10/70; G06V 20/58

(52) U.S. Cl. CPC B60W 60/001; B60W 50/00; G01C 21/3815; G01C 21/3837; G06V 10/70; G06V 20/582; B60W 2050/0005; B60W 2420/403; B60W 2555/60; B60W 2556/40

(57) ABSTRACT

A method for adjusting operation of a vehicle based on traffic control devices may include receiving information about a traffic control device in an environment surrounding the vehicle. The method further may include determining a relevancy status of the traffic control device based at least in part on the information about the traffic control device. The method further may include determining a road configuration indicated by the information about the traffic control device in response to determining that the relevancy status is a relevant status. The method further may include generating an updated environmental map based at least in part on the road configuration indicated by the information about the traffic control device and an existing environmental map. The method further may include adjusting an operation of an automated driving system of the vehicle based at least in part on the updated environmental map.

### INTRODUCTION

The present disclosure relates to systems and methods for real-time environmental mapping for vehicles.

To support functions such as navigation, obstacle detection, and autonomous operation, real-time environmental mapping systems may be utilized. These systems are configured to generate representations of the vehicle's surroundings using data collected from one or more sensors. In some examples, the sensors include cameras, light detection and ranging (LIDAR), radar, and/or the like. The data from these sensors may be processed by onboard computational systems to construct dynamic maps of the vehicle's environment. These maps may represent static features, such as roadways, curbs, and traffic signs, as well as dynamic objects, such as pedestrians, vehicles, and animals. In some implementations, environmental mapping may be combined with localization techniques to enable situational awareness and positioning relative to known features. Environmental maps may be updated continuously to reflect changes in the vehicle's environment. In some examples, the environmental mapping system may operate in conjunction with automated driving functions to support navigation and control decisions.

While systems and methods for environmental mapping achieve their intended purpose, there is a need for new and improved systems and methods for environmental mapping including adjusting operation of a vehicle based on traffic control devices in the environment.

### SUMMARY

According to several aspects, a method for adjusting operation of a vehicle based on traffic control devices is provided. The method may include receiving information about a traffic control device in an environment surrounding the vehicle. The method further may include determining a relevancy status of the traffic control device based at least in part on the information about the traffic control device. The relevancy status includes one of a relevant status and an irrelevant status. The method further may include determining a road configuration indicated by the information about the traffic control device in response to determining that the relevancy status is the relevant status. The method further may include generating an updated environmental map based at least in part on the road configuration indicated by the information about the traffic control device and an existing environmental map. The updated environmental map includes information about road configurations in the environment surrounding the vehicle. The method further may include adjusting an operation of an automated driving system of the vehicle based at least in part on the updated environmental map.

In another aspect of the present disclosure, determining the relevancy status of the traffic control device further may include determining a novelty status of the traffic control device. The novelty status includes one of a novel status and a non-novel status. Determining the relevancy status of the traffic control device further may include determining the relevancy status of the traffic control device to be the relevant status in response to determining that the novelty status of the traffic control device is the novel status. Determining the relevancy status of the traffic control device further may include determining the relevancy status of the traffic control device based at least in part on a location of the vehicle relative to the traffic control device in response to determining that the novelty status of the traffic control device is the non-novel status.

In another aspect of the present disclosure, determining the novelty status of the traffic control device further may include querying a non-transitory memory of a controller of the vehicle for a matching record corresponding to the traffic control device based at least in part on the information about the traffic control device and a location of the traffic control device. Determining the novelty status of the traffic control device further may include determining the novelty status of the traffic control device to be the non-novel status in response to determining that the non-transitory memory does include the matching record corresponding to the traffic control device. Determining the novelty status of the traffic control device further may include determining the novelty status of the traffic control device to be the novel status in response to determining that the non-transitory memory does not include the matching record corresponding to the traffic control device.

In another aspect of the present disclosure, determining the relevancy status of the traffic control device further may include determining a location of the road configuration indicated by the information about the traffic control device based at least in part on a road regulation. Determining the relevancy status of the traffic control device further may include determining a location of the vehicle relative to the location of the road configuration indicated by the information about the traffic control device. Determining the relevancy status of the traffic control device further may include determining the relevancy status of the traffic control device to be the irrelevant status in response to determining that a distance between the location of the vehicle and the location of the road configuration indicated by the information about the traffic control device is increasing over time. Determining the relevancy status of the traffic control device further may include determining the relevancy status of the traffic control device to be the relevant status in response to determining that the distance between the location of the vehicle and the location of the road configuration indicated by the information about the traffic control device is decreasing over time.

In another aspect of the present disclosure, determining the road configuration indicated by the information about the traffic control device further may include querying a non-transitory memory of a controller of the vehicle for a similar record based at least in part on the information about the traffic control device. The similar record includes information which is similar to the information about the traffic control device. Determining the road configuration indicated by the information about the traffic control device further may include retrieving the road configuration indicated by the information about the traffic control device from the non-transitory memory in response to determining that the non-transitory memory does include the similar record. Determining the road configuration indicated by the information about the traffic control device further may include determining the road configuration indicated by the information about the traffic control device using a machine learning model based at least in part on the information about the traffic control device in response to determining that the non-transitory memory does not include the similar record.

In another aspect of the present disclosure, determining the road configuration indicated by the information about the traffic control device using a machine learning model further may include determining the road configuration indicated by the information about the traffic control device using a machine learning model based at least in part on the information about the traffic control device. The machine learning model is a large language model (LLM).

In another aspect of the present disclosure, querying the non-transitory memory for the similar record further may include determining a similarity score between the information about the traffic control device and information in each of a plurality of records in the non-transitory memory. Querying the non-transitory memory for the similar record further may include identifying the similar record of the plurality of records in response to determining that the similarity score between the information about the traffic control device and information in the similar record is greater than or equal to a predetermined similarity threshold.

In another aspect of the present disclosure, generating the updated environmental map further may include determining one or more discrepancies between the existing environmental map and the road configuration indicated by the information about the traffic control device. Generating the updated environmental map further may include determining one or more modifications to the existing environmental map based at least in part on the one or more discrepancies and the road configuration indicated by the information about the traffic control device. Generating the updated environmental map further may include modifying the existing environmental map based at least in part on the one or more modifications to generate the updated environmental map.

In another aspect of the present disclosure, determining one or more modifications to the existing environmental map further may include determining the one or more modifications to the existing environmental map using a rule-based algorithm based at least in part on the one or more discrepancies and the road configuration indicated by the information about the traffic control device.

In another aspect of the present disclosure, receiving information about the traffic control device in the environment surrounding the vehicle further may include capturing an image of the traffic control device. The traffic control device includes a traffic sign.

According to several aspects, a system for adjusting operation of a vehicle based on traffic signs is provided. The system may include a camera, an automated driving system, and a controller in electrical communication with the camera and the automated driving system. The controller is programmed to capture an image of a traffic sign in an environment surrounding the vehicle using the camera. The controller is further programmed to determine a relevancy status of the traffic sign based at least in part on the image of the traffic sign. The relevancy status includes one of a relevant status and an irrelevant status. The controller is further programmed to determine a road configuration indicated by the image of the traffic sign in response to determining that the relevancy status is the relevant status. The controller is further programmed to generate an updated environmental map based at least in part on the road configuration indicated by the image of the traffic sign and an existing environmental map. The updated environmental map includes information about road configurations in the environment surrounding the vehicle. The controller is further programmed to adjust an operation of the automated driving system based at least in part on the updated environmental map.

In another aspect of the present disclosure, to determine the relevancy status of the traffic sign, the controller is further programmed to determine a novelty status of the traffic sign. The novelty status includes one of a novel status and a non-novel status. To determine the relevancy status of the traffic sign, the controller is further programmed to determine the relevancy status of the traffic sign to be the relevant status in response to determining that the novelty status of the traffic sign is the novel status. To determine the relevancy status of the traffic sign, the controller is further programmed to determine the relevancy status of the traffic sign based at least in part on a location of the vehicle relative to the road configuration indicated by the image of the traffic sign in response to determining that the novelty status of the traffic sign is the non-novel status.

In another aspect of the present disclosure, to determine the novelty status of the traffic sign, the controller is further programmed to query a non-transitory memory of the controller for a matching record corresponding to the traffic sign based at least in part on the image of the traffic sign and a location of the traffic sign. To determine the novelty status of the traffic sign, the controller is further programmed to determine the novelty status of the traffic sign to be the non-novel status in response to determining that the non-transitory memory does include the matching record corresponding to the traffic sign. To determine the novelty status of the traffic sign, the controller is further programmed to determine the novelty status of the traffic sign to be the novel status in response to determining that the non-transitory memory does not include the matching record corresponding to the traffic sign. To determine the novelty status of the traffic sign, the controller is further programmed to save a new record for the traffic sign in the non-transitory memory in response to determining that the novelty status of the traffic sign is the novel status.

In another aspect of the present disclosure, to determine the relevancy status of the traffic sign, the controller is further programmed to determine a location of the road configuration indicated by the image of the traffic sign based at least in part on a road regulation. To determine the relevancy status of the traffic sign, the controller is further programmed to determine a location of the vehicle relative to the location of the road configuration indicated by the image of the traffic sign. To determine the relevancy status of the traffic sign, the controller is further programmed to determine the relevancy status of the traffic sign to be the irrelevant status in response to determining that a distance between the location of the vehicle and the location of the road configuration indicated by the image of the traffic sign is increasing over time. To determine the relevancy status of the traffic sign, the controller is further programmed to determine the relevancy status of the traffic sign to be the relevant status in response to determining that the distance between the location of the vehicle and the location of the road configuration indicated by the image of the traffic sign is decreasing over time. To determine the relevancy status of the traffic sign, the controller is further programmed to query the non-transitory memory of the controller for a matching record corresponding to the traffic sign based at least in part on the image of the traffic sign and a location of the traffic sign. To determine the relevancy status of the traffic sign, the controller is further programmed to delete the matching record corresponding to the traffic sign from the non-transitory memory in response to determining the relevancy status of the traffic sign to be the irrelevant status.

In another aspect of the present disclosure, to determine the road configuration indicated by the image of the traffic sign, the controller is further programmed to query a non-transitory memory of the controller for a similar record based at least in part on the image of the traffic sign. The similar record includes information which is similar to the image of the traffic sign. To determine the road configuration indicated by the image of the traffic sign, the controller is further programmed to retrieve the road configuration indicated by the image of the traffic sign from the non-transitory memory in response to determining that the non-transitory memory does include the similar record. To determine the road configuration indicated by the image of the traffic sign, the controller is further programmed to determine the road configuration indicated by the image of the traffic sign using a large language model (LLM) machine learning model based at least in part on the image of the traffic sign in response to determining that the non-transitory memory does not include the similar record. To determine the road configuration indicated by the image of the traffic sign, the controller is further programmed to save a new record for the traffic sign in the non-transitory memory in response to determining the road configuration indicated by the image of the traffic sign using the machine learning model.

In another aspect of the present disclosure, to generate the updated environmental map, the controller is further programmed to determine one or more discrepancies between the existing environmental map and the road configuration indicated by the image of the traffic sign. To generate the updated environmental map, the controller is further programmed to determine one or more modifications to the existing environmental map using a rule-based algorithm based at least in part on the one or more discrepancies and the road configuration indicated by the image of the traffic sign. To generate the updated environmental map, the controller is further programmed to modify the existing environmental map based at least in part on the one or more modifications to generate the updated environmental map.

In another aspect of the present disclosure, to adjust the operation of the automated driving system, the controller is further programmed to recalculate a vehicle path using a path planning algorithm of the automated driving system based at least in part on the modifications to the existing environmental map. To adjust the operation of the automated driving system, the controller is further programmed to control the vehicle to drive the vehicle along the vehicle path using the automated driving system.

According to several aspects, a method for adjusting operation of a vehicle based on traffic control devices is provided. The method may include receiving information about a traffic sign in an environment surrounding the vehicle. The method further may include determining a novelty status of the traffic sign. The novelty status includes one of a novel status and a non-novel status. The method further may include determining a relevancy status of the traffic sign to be a relevant status in response to determining that the novelty status of the traffic sign is the novel status. The method further may include determining the relevancy status of the traffic sign based at least in part on a location of the vehicle relative to the traffic sign in response to determining that the novelty status of the traffic sign is the non-novel status. The method further may include determining a road configuration indicated by the information about the traffic sign in response to determining that the relevancy status is the relevant status. The method further may include generating an updated environmental map based at least in part on the road configuration indicated by the information about the traffic sign and an existing environmental map. The updated environmental map includes information about road configurations in the environment surrounding the vehicle. The method further may include adjusting an operation of an automated driving system of the vehicle based at least in part on the updated environmental map.

In another aspect of the present disclosure, determining the road configuration indicated by the information about the traffic sign further may include querying a non-transitory memory of a controller of the vehicle for a similar record based at least in part on the information about the traffic sign. The similar record includes information which is similar to the information about the traffic sign. Determining the road configuration indicated by the information about the traffic sign further may include retrieving the road configuration indicated by the information about the traffic sign from the non-transitory memory in response to determining that the non-transitory memory does include the similar record. Determining the road configuration indicated by the information about the traffic sign further may include determining the road configuration indicated by the information about the traffic sign using a large language model (LLM) machine learning model based at least in part on the information about the traffic sign in response to determining that the non-transitory memory does not include the similar record.

In another aspect of the present disclosure, querying the non-transitory memory for the similar record further may include determining a similarity score between the information about the traffic sign and information in each of a plurality of records in the non-transitory memory. Querying the non-transitory memory for the similar record further may include identifying the similar record of the plurality of records in response to determining that the similarity score between the information about the traffic sign and information in the similar record is greater than or equal to a predetermined similarity threshold.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a system for adjusting operation of a vehicle based on traffic control devices, according to an exemplary embodiment;

FIG. 2 is a flowchart of a method for adjusting operation of a vehicle based on traffic control devices, according to an exemplary embodiment; and

FIG. 3 is a schematic diagram of an exemplary roadway for illustrating the functioning of an exemplary memory governor module, according to an exemplary embodiment.

### DETAILED DESCRIPTION

The following description is merely exemplary in nature and is not intended to limit the present disclosure, application, or uses.

In aspects of the present disclosure, it is advantageous to update environmental maps based on traffic control devices (e.g., traffic signs) in the environment surrounding a vehicle. This enables increased performance for driver assistance and automated driving systems of the vehicle by providing more accurate and current information. However, utilizing information from traffic control devices requires understanding of the context of the traffic control devices in the environment. Therefore, the present disclosure provides a new and improved system and method for updating environmental maps and adjusting the operation of a vehicle which utilizes memory to accurately interpret traffic control devices.

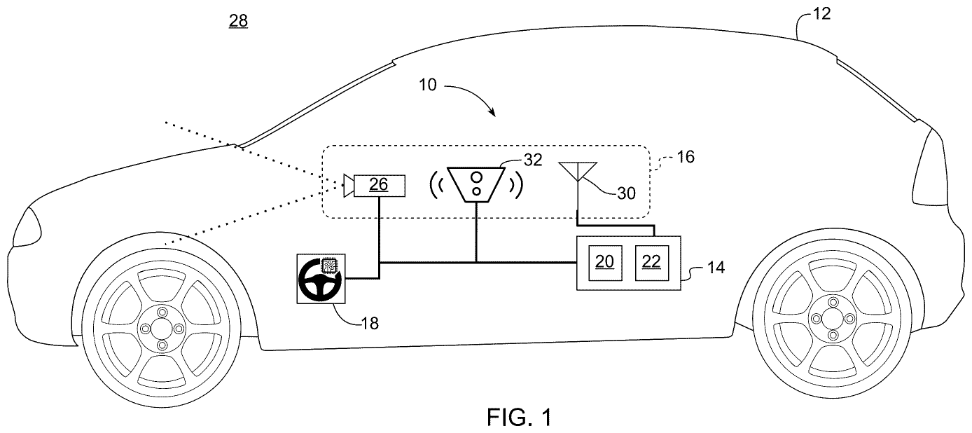

Referring to FIG. 1, a system for adjusting operation of a vehicle based on traffic control devices is illustrated and generally indicated by reference number 10. The system 10 is shown with an exemplary vehicle 12. While a passenger vehicle is illustrated, it should be appreciated that the vehicle 12 may be any type of vehicle without departing from the scope of the present disclosure. The system 10 generally includes a controller 14, one or more sensors 16, and an automated driving system 18.

The controller 14 is used to implement a method 100 for adjusting operation of a vehicle based on traffic control devices, as will be described below. The controller 14 includes at least one processor 20 and a non-transitory computer readable storage device, memory, or media 22. The processor 20 may be a custom made or commercially available processor, a central processing unit (CPU), a graphics processing unit (GPU), an auxiliary processor among several processors associated with the controller 14, a semiconductor-based microprocessor (in the form of a microchip or chip set), a macroprocessor, a combination thereof, or generally a device for executing instructions.

The computer readable storage device or media 22 may include volatile and nonvolatile storage in read-only memory (ROM), random-access memory (RAM), and keep-alive memory (KAM), for example. KAM is a persistent or non-volatile memory that may be used to store various operating variables while the processor 20 is powered down. The computer-readable storage device or media 22 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the controller 14 to control various systems of the vehicle 12. It should be understood that the media 22 may be realized as one unified memory device, as multiple separate memory devices, and/or as multiple virtual memory containers (e.g., partitions) on one or more memory devices without departing from the scope of the present disclosure.

The controller 14 may also include multiple controllers which are in electrical communication with each other. The controller 14 may be inter-connected with additional systems and/or controllers of the vehicle 12, allowing the controller 14 to access data such as, for example, speed, acceleration, braking, and steering angle of the vehicle 12.

The controller 14 is in electrical communication with the one or more sensors 16 and the automated driving system 18. In an exemplary embodiment, the electrical communication is established using, for example, a CAN network, a FLEXRAY network, a local area network (e.g., WiFi, ethernet, and the like), a serial peripheral interface (SPI) network, or the like. It should be understood that various additional wired and wireless techniques and communication protocols for communicating with the controller 14 are within the scope of the present disclosure. It should further be understood that, in the scope of the present disclosure, electrical communication also includes power and/or energy transfer between electrical devices (e.g., using conducting wires and/or wireless power transmission techniques).

The one or more sensors 16 are used to acquire information relevant to the vehicle 12. In an exemplary embodiment, the one or more sensors 16 includes at least a camera system 26.

The camera system 26 is a perception sensor used to capture images and/or videos of an environment 28 surrounding the vehicle 12. In an exemplary embodiment, the camera system 26 includes a photo and/or video camera which is positioned to view the environment 28 surrounding the vehicle 12. In a non-limiting example, the camera system 26 includes a camera affixed inside of the vehicle 12, for example, in a headliner of the vehicle 12, having a view through a windscreen of the vehicle 12. In another non-limiting example, the camera system 26 includes a camera affixed outside of the vehicle 12, for example, on a roof of the vehicle 12, having a view of the environment 28 in front of the vehicle 12.

In another exemplary embodiment, the camera system 26 is a surround view camera system including a plurality of cameras (also known as satellite cameras) arranged to provide a view of the environment 28 adjacent to all sides of the vehicle 12. In a non-limiting example, the camera system 26 includes a front-facing camera (mounted, for example, in a front grille of the vehicle 12), a rear-facing camera (mounted, for example, on a rear tailgate of the vehicle 12), and two side-facing cameras (mounted, for example, under each of two side-view mirrors of the vehicle 12). In another non-limiting example, the camera system 26 further includes an additional rear-view camera mounted near a center high mounted stop lamp of the vehicle 12.

It should be understood that camera systems having additional cameras and/or additional mounting locations are within the scope of the present disclosure. The camera system 26 is in electrical communication with the controller 14, as discussed above.

In another exemplary embodiment, the one or more sensors 16 further includes sensors to determine performance data about the vehicle 12. In a non-limiting example, the one or more sensors 16 further includes at least one of a motor speed sensor, a motor torque sensor, an electric drive motor voltage and/or current sensor, an accelerator pedal position sensor, a brake position sensor, a coolant temperature sensor, a cooling fan speed sensor, and a transmission oil temperature sensor.

In another exemplary embodiment, the one or more sensors 16 further includes sensors to determine information about an environment within the vehicle 12. In a non-limiting example, the one or more sensors 16 further includes at least one of a seat occupancy sensor, a cabin air temperature sensor, a cabin motion detection sensor, a cabin camera, a cabin microphone, and/or the like.

In another exemplary embodiment, the one or more sensors 16 further includes sensors to determine information about the environment 28 surrounding the vehicle 12. In a non-limiting example, the one or more sensors 16 further includes at least one of an ambient air temperature sensor, a barometric pressure sensor, a global navigation satellite system (GNSS), a vehicle communication system 30, and/or the like.

The vehicle communication system 30 is used by the controller 14 to communicate with other systems external to the vehicle 12. For example, the vehicle communication system 30 includes capabilities for communication with vehicles (“V2V” communication), infrastructure (“V2I” communication), remote systems at a remote call center (e.g., ON-STAR by GENERAL MOTORS) and/or personal devices. In general, the term vehicle-to-everything communication (“V2X” communication) refers to communication between the vehicle 12 and any remote system (e.g., vehicles, infrastructure, and/or remote systems).

In certain embodiments, the vehicle communication system 30 is a wireless communication system configured to communicate via a wireless local area network (WLAN) using IEEE 802.11 standards or by using cellular data communication (e.g., using GSMA standards, such as, for example, SGP.02, SGP.22, SGP.32, and the like). Accordingly, the vehicle communication system 30 may further include an embedded universal integrated circuit card (eUICC) configured to store at least one cellular connectivity configuration profile, for example, an embedded subscriber identity module (eSIM) profile.

The vehicle communication system 30 is further configured to communicate via a personal area network (e.g., BLUETOOTH), near-field communication (NFC), and/or any additional type of radiofrequency communication. However, additional or alternate communication methods, such as a dedicated short-range communications (DSRC) channel and/or mobile telecommunications protocols based on the 3rd Generation Partnership Project (3GPP) standards, are also considered within the scope of the present disclosure. DSRC channels refer to one-way or two-way short-range to medium-range wireless communication channels specifically designed for automotive use and a corresponding set of protocols and standards. The 3GPP refers to a partnership between several standards organizations which develop protocols and standards for mobile telecommunications. 3GPP standards are structured as “releases”. Thus, communication methods based on 3GPP release 14, 15, 16 and/or future 3GPP releases are considered within the scope of the present disclosure.

Accordingly, the vehicle communication system 30 may include one or more antennas and/or communication transceivers for receiving and/or transmitting signals, such as cooperative sensing messages (CSMs). The vehicle communication system 30 is configured to wirelessly communicate information between the vehicle 12 and another vehicle. Further, the vehicle communication system 30 is configured to wirelessly communicate information between the vehicle 12 and infrastructure or other vehicles. It should be understood that the vehicle communication system 30 may be integrated with the controller 14 (e.g., on a same circuit board with the controller 14 or otherwise a part of the controller 14) without departing from the scope of the present disclosure.

In another exemplary embodiment, the one or more sensors 16 includes additional perception sensors capable of perceiving objects and/or measuring distances in the environment 28 surrounding the vehicle 12. In a non-limiting example, the one or more sensors 16 further includes at least one of an ultrasonic ranging sensor, a radar sensor, a time-of-flight sensor, a LIDAR sensor 32, and/or the like.

The LIDAR sensor 32 is utilized for remote sensing and environmental mapping by emitting laser pulses and measuring the time it takes for the laser pulses to return to the LIDAR sensor 32 after hitting objects. In an exemplary embodiment, the LIDAR sensor 32 includes a LIDAR laser source, a LIDAR scanner or mirror, a LIDAR photodetector, and a LIDAR time-of-flight measurement system. In a non-limiting example, the LIDAR laser source emits laser pulses that travel to the target area, and the LIDAR scanner directs these pulses in different directions. The emitted laser pulses interact with objects in the environment and their reflections are captured by the LIDAR photodetector. The LIDAR time-of-flight measurement system calculates the distance to the objects based on the time between emission of the laser pulses by the LIDAR laser source and reception of the reflected laser pulses by the LIDAR photodetector. The LIDAR sensor 32 is in electrical communication with the controller 14, as discussed above.

In one example, at least one of the one or more sensors 16 is affixed inside of the vehicle 12, for example, in a headliner of the vehicle 12, having a view through the windscreen of the vehicle 12. In another example, at least one of the one or more sensors 16 is affixed outside of the vehicle 12, for example, on a roof of the vehicle 12, having a view of the environment 28 surrounding the vehicle 12. It should be understood that the various types of sensors discussed above are merely exemplary in nature, and that the one or more sensors 16 may include various additional and/or alternative sensors without departing from the scope of the present disclosure. The one or more sensors 16 are in electrical communication with the controller 14 as discussed above.

The automated driving system 18 is used to provide assistance to an occupant of the vehicle 12 to increase occupant awareness and/or control behavior of the vehicle 12. In the scope of the present disclosure, the automated driving system 18 encompasses systems which provide any level of assistance to the occupant (e.g., blind spot warning, lane departure warning, and/or the like) and systems which are capable of autonomously driving the vehicle 12 under some or all conditions (e.g., automated lane keeping, adaptive cruise control, fully autonomous driving, and/or the like). It should be understood that all levels of driving automation defined by, for example, SAE J3016 (i.e., SAE LEVEL 0, SAE LEVEL 1, SAE LEVEL 2, SAE LEVEL 3, SAE LEVEL 4, and SAE LEVEL 5) are within the scope of the present disclosure.

In an exemplary embodiment, the automated driving system 18 is configured to detect and/or receive information about the environment 28 surrounding the vehicle 12 and process the information to provide assistance to the occupant. In some embodiments, the automated driving system 18 is a software module executed on the controller 14. In other embodiments, the automated driving system 18 includes a separate automated driving system controller, similar to the controller 14, capable of processing the information about the environment 28 surrounding the vehicle 12. In an exemplary embodiment, the automated driving system 18 may operate in a manual operation mode, a partially automated operation mode, and a fully automated operation mode.

In the scope of the present disclosure, the manual operation mode means that the automated driving system 18 provides warnings or notifications to the occupant but does not intervene or control the vehicle 12 directly. In a non-limiting example, the automated driving system 18 receives information from the one or more sensors 16. Using techniques such as, for example, computer vision, the automated driving system 18 understands the environment 28 surrounding the vehicle 12 and provides assistance to the occupant. For example, if the automated driving system 18 identifies, based on data from the one or more sensors 16, that the vehicle 12 is likely to collide with a remote vehicle, the automated driving system 18 may use a display to provide a warning to the occupant.

In the scope of the present disclosure, the partially automated operation mode means that the automated driving system 18 provides warnings or notifications to the occupant and may intervene or control the vehicle 12 directly in certain situations. In a non-limiting example, the automated driving system 18 is additionally in electrical communication with components of the vehicle 12 such as a brake system, a propulsion system, and/or a steering system of the vehicle 12, such that the automated driving system 18 may control the behavior of the vehicle 12. In a non-limiting example, the automated driving system 18 may control the behavior of the vehicle 12 by applying brakes of the vehicle 12 to avoid an imminent collision. In another non-limiting example, the automated driving system 18 may control the steering system of the vehicle 12 to provide an automated lane keeping feature. In another non-limiting example, the automated driving system 18 may control the brake system, propulsion system, and steering system of the vehicle 12 to temporarily drive the vehicle 12 towards a predetermined destination. However, intervention by the occupant may be required at any time. In an exemplary embodiment, the automated driving system 18 may include additional components such as, for example, an eye tracking device configured to monitor an attention level of the occupant and ensure that the occupant is prepared to take over control of the vehicle 12.

In the scope of the present disclosure, the fully automated operation mode means that the automated driving system 18 uses data from the one or more sensors 16 to understand the environment 28 and control the vehicle 12 to drive the vehicle 12 to a predetermined destination without a need for control or intervention by the occupant.

The automated driving system 18 operates using a path planning algorithm which is configured to generate a safe and efficient trajectory for the vehicle 12 to navigate in the environment surrounding the vehicle 12. In an exemplary embodiment, the path planning algorithm is a machine learning algorithm trained to output control signals for the vehicle 12 based on input data collected from the one or more sensors 16. In another exemplary embodiment, the path planning algorithm is a deterministic algorithm which has been programmed to output control signals for the vehicle 12 based on data collected from the one or more sensors 16.

In a non-limiting example, the path planning algorithm generates a sequence of waypoints or a continuous path that the vehicle 12 should follow to reach a destination while adhering to rules, regulations, and safety constraints. The sequence of waypoints or continuous path is generated based at least in part on an environmental map and a current state of the vehicle 12 (i.e., position, velocity, and orientation of the vehicle 12). The environmental map includes, for example, information about lane boundaries, road geometry, and/or other relevant features. In an exemplary embodiment, the environmental map is stored in the media 22 of the controller 14 and/or on a remote database or server. In another exemplary embodiment, data collected from the one or more sensors 16 is interpreted to create, update, and/or augment the environmental map, as will be discussed in greater detail below.

It should be understood that the automated driving system 18 may include any software and/or hardware module configured to operate in the manual operation mode, the partially automated operation mode, or the fully automated operation mode as described above. The automated driving system 18 is in electrical communication with the controller 14, as discussed above.

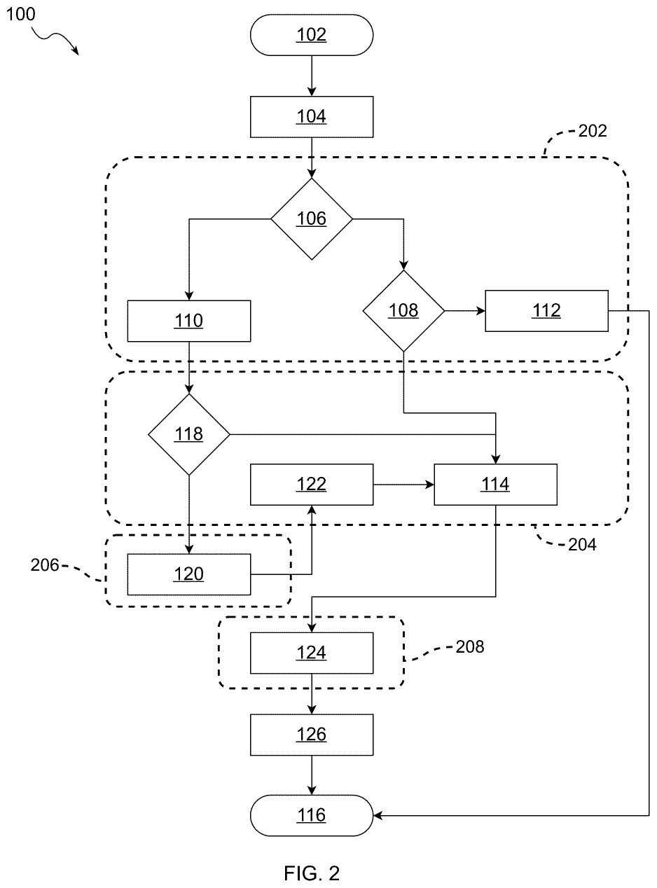

Referring to FIG. 2, a flowchart of the method 100 for adjusting operation of a vehicle based on traffic control devices is shown. The method 100 begins at block 102 and proceeds to block 104. At block 104, the controller 14 uses the one or more sensors 16 to receive information about a traffic control device in the environment 28 surrounding the vehicle 12. In the scope of the present disclosure, a traffic control device includes signs, signals, markings, or other features used to regulate traffic flow, such as, for example, traffic signs, traffic lights, road markings, rumble strips, and/or the like. In the scope of the present disclosure, the information about the traffic control device may include images of the traffic control device, physical characteristics (e.g., shape, size, color, etc.) of the traffic control device, content of text, images, or pictograms printed or displayed on the traffic control device, status of lamps, lights, or other dynamic visual indicators of the traffic control device, and/or contextual information about the traffic control device such as location, height, or angle, and/or the like. In an exemplary embodiment, the controller 14 uses the camera system 26 of the one or more sensors 16 to capture an image of a traffic control device (e.g., a traffic sign) in the environment 28. In another exemplary embodiment, the controller 14 uses the one or more sensors 16 to determine a location of the traffic control device relative to the vehicle 12. After block 104, the method 100 proceeds to block 106.

At block 106, the controller 14 determines a novelty status of the traffic control device of block 104. In the scope of the present disclosure, the novelty status indicates whether the controller 14 has previously received information about this particular traffic control device. For example, when traversing a roadway, the one or more sensors 16 may receive information about a same traffic control device multiple times (e.g., as the vehicle 12 approaches a traffic sign, the camera system 26 may capture multiple images at different times, with two or more of the multiple images including the same traffic sign). The novelty status includes one of: a novel status (i.e., the information received at block 104 is the first information received about the particular traffic control device) and a non-novel status (i.e., the information received at block 104 is not the first information received about the particular traffic control device).

In an exemplary embodiment, to determine the novelty status, the controller 14 queries the media 22 for a matching record corresponding to the traffic control device. In a non-limiting example, the controller 14 queries the media 22 based on the information about the traffic control device determined at block 104. For example, where the information includes an image, the controller 14 queries the media 22 for records having matching shape, size, text, color, etc.. For example, the controller 14 may extract text from the information about the traffic control device (e.g., text written on a traffic sign) and search the media 22 based on the extracted text. In another non-limiting example, the controller 14 queries the media 22 based on the location of the traffic control device. For example, the controller 14 uses dead reckoning based on the speed and heading of the vehicle 12 to track the location of the traffic control device relative to the vehicle 12. The controller 14 then queries the media 22 for records having a location within a predetermined radius (e.g., one meter) of the location of the traffic control device. If the media 22 does include the matching record corresponding to the traffic control device of block 104, the novelty status is determined to be the non-novel status and the method 100 proceeds to block 108. If the media 22 does not include the matching record corresponding to the traffic control device of block 104, the novelty status is determined to be the novel status and the method 100 proceeds to block 110, as will be discussed in greater detail below.

At block 108, the controller 14 determines a relevancy status of the traffic control device of block 104. In the scope of the present disclosure, the relevancy status indicates whether the traffic control device of block 104 is still relevant to a future path of the vehicle 12. The relevancy status includes one of: a relevant status and an irrelevant status. In an exemplary embodiment, the relevancy status is determined based at least in part on a location of the vehicle 12 relative to the traffic control device in response to determining that the novelty status is the non-novel status. In a non-limiting example, the controller 14 first determines a location of a road configuration indicated by the information about the traffic control device. In the scope of the present disclosure, the road configuration indicated by the information about the traffic control device a road characteristic, condition, or configuration indicated or referred to by the traffic control device. For example, if the traffic control device is a traffic sign which states “lane ends”, the location of the road configuration indicated by the traffic sign is at a point ahead of the traffic sign where the lane ends.

In an exemplary embodiment, the controller 14 determines the location of the road configuration indicated by the information about the traffic control device based on one or more road rules or regulations. In a non-limiting example, the controller 14 uses road rules or regulations from the Manual on Uniform Traffic Control Devices (MUTCD) to determine the location of the road configuration indicated by the information about the traffic control device based on shape, size, color, content, and/or the like of the traffic control device. For example, the MUTCD specifies that “lane ends” signs should be placed to provide vehicles with adequate time, for example, 14.0 to 14.5 seconds, to react before the lane ends. Therefore, based on the location of the traffic control device, the road regulations, and/or additional information (e.g., the speed limit or average travel speed of the roadway), the location of the road configuration indicated by the information about the traffic control device is determined.

In another exemplary embodiment, the controller 14 determines the location of the road configuration indicated by the information about the traffic control device based on data received using the one or more sensors 16. In a non-limiting example, the one or more sensors 16 are used to gather perception data, and the location of the road configuration indicated by the information about the traffic control device is extrapolated from the perception data.

After determining the location of a road configuration indicated by the information about the traffic control device, the controller 14 determines a location of the vehicle 12 relative to the location of the road configuration. In an exemplary embodiment, the controller 14 determines the location of the vehicle 12 relative to the location of the road configuration using dead reckoning to track the location of the vehicle 12 relative to the location of the traffic control device based on a speed and heading of the vehicle 12 and an elapsed time since receiving the information about the traffic control device at block 104. In another exemplary embodiment, the controller 14 uses the one or more sensors 16 to determine the location of the vehicle 12 relative to the location of the road configuration based on, for example, perception data and/or GNSS data.

After determining the location of the vehicle 12 relative to the location of the road configuration, the controller 14 repeatedly recalculates the location of the vehicle 12 relative to the location of the road configuration to determine whether a distance between the location of the vehicle 12 and the location of the road configuration is increasing or decreasing over time. If the distance between the location of the vehicle 12 and the location of the road configuration is increasing, the vehicle 12 is departing the location of the road configuration indicated by the traffic control device. Therefore, the relevancy status of the traffic control device is determined to be the irrelevant status, and the method 100 proceeds to block 112. If the distance between the location of the vehicle 12 and the location of the road configuration is decreasing, the vehicle 12 is approaching the location of the road configuration indicated by the traffic control device. Therefore, the relevancy status of the traffic control device is determined to be the relevant status, and the method 100 proceeds to block 114, as will be discussed in greater detail below.

At block 112, the controller 14 deletes the matching record corresponding to the traffic control device found at block 106 from the media 22 in response to determining that the relevancy status of the traffic control device is the irrelevant status. In another exemplary embodiment, rather than deleting the matching record, the controller 14 marks the matching record as irrelevant but otherwise retains the matching record. After block 112, the method 100 proceeds to enter a standby state at block 116.

At block 110, the controller 14 saves a new record for the traffic control device of block 104 in the media 22 in response to determining that the novelty status of the traffic control device is the novel status. After block 110, the method 100 proceeds to block 118.

At block 118, the controller 14 queries the media 22 for a similar record to the traffic control device of block 104. In the scope of the present disclosure, the similar record corresponds to a traffic control device having a similar meaning to the particular traffic control device of block 104. In an exemplary embodiment, to query the media 22 for a similar record to the traffic control device of block 104, the controller 14 determines a similarity score between the information about the traffic control device determined at block 104 and information in each of a plurality of records stored in the media 22. In a non-limiting example, to determine the similarity scores, the controller 14 generates an embedding vector for the information about the traffic control device determined at block 104 and embedding vectors for each of the plurality of records stored in the media 22. By comparing the embedding vectors (e.g., using a dot product), the controller 14 determines the similarity score for each of the plurality of records.

In a non-limiting example, the controller 14 identifies the similar record as one of the plurality of records having a highest similarity score. In another non-limiting example, the controller 14 identifies the similar record as one of the plurality of records having a similarity score greater than or equal to a predetermined similarity threshold. In another non-limiting example, the controller 14 identifies the similar record as one of the plurality of records having a highest similarity score greater than or equal to the predetermined similarity threshold. If no similar record is found in the media 22, the method 100 proceeds to block 120. If the similar record is found in the media 22, the method 100 proceeds to block 114, as will be discussed in greater detail below.

At block 120, the controller 14 determines the road configuration indicated by the traffic control device of block 104 using a machine learning model based at least in part on the information about the traffic control device received at block 104 in response to determining that the media 22 does not include the similar record. In an exemplary embodiment, the controller 14 passes the information about the traffic control device received at block 104 (e.g., an image of the traffic control device) to the machine learning model, and the machine learning model provides a machine-readable response (e.g., in the form of a data structure) which describes the road configuration indicated by the traffic control device.

For example, if the information about the traffic control device is an image of an intersection lane control traffic sign (i.e., a traffic sign indicating which lanes are permitted to turn and/or proceed straight at an intersection), the machine learning model provides a data structure (e.g., an array) indicating the permitted usage of each lane as indicated by the traffic sign. In another example, if the information about the traffic control device is an image of a warning traffic sign (e.g., a “lane ends” traffic sign), the machine learning model provides a data structure (e.g., a tuple) including an alphanumeric sign designation (e.g., “W4-2” for the “lane ends” sign) and a corresponding lane for which the traffic sign applies (e.g., “1” for the number one lane).

It should be understood that the examples of machine learning model inputs and outputs discussed above are merely exemplary in nature, and that the machine learning model may be configured to provide an output in any type of machine-readable format. It should be understood that various types and configurations of machine learning models may be utilized within the scope of the present disclosure, including, for example, a large language model (LLM) and/or the like. It should also be understood that the machine learning model may be executed using the controller 14, an integrated or external graphics processing unit (GPU), another dedicated module, controller, or computer of the vehicle 12, and/or an external device or server. After block 120, the method 100 proceeds to block 122.

At block 122, the controller 14 saves a new record for the traffic control device of block 104 in the media 22 in response to determining the road configuration indicated by the information about the traffic control device at block 120. In an exemplary embodiment, the record includes the information about the traffic control device received at block 104 and the corresponding machine-readable road configuration determined at block 120 using the machine learning model. Therefore, if a similar traffic control device is encountered in the future, the media 22 may be queried to determine the meaning of the traffic control device (i.e., the road configuration indicated by the information about the traffic control device) without executing the machine learning model, allowing for faster processing. Furthermore, the media 22 will accumulate records corresponding to commonly encountered traffic control devices, reducing the frequency that the machine learning model is executed, thus conserving computing resources. After block 122, the method 100 proceeds to block 114.

At block 114, the controller 14 retrieves the road configuration indicated by the information about the traffic control device from the media 22 in response to determining that the media 22 does include the matching record at block 106 and that the relevancy status is the relevant status at block 108, or in response to determining that the media 22 does include the similar record at block 118, or in response to saving the new record to the media 22 at block 122. In an exemplary embodiment, the controller 14 queries the media 22 to retrieve the road configuration indicated by the information about the traffic control device. In a non-limiting example, the controller 14 retrieves the road configuration from the matching record in the media 22. In another non-limiting example, the controller 14 retrieves the road configuration from the similar record in the media 22. In another non-limiting example, the controller 14 retrieves the road configuration from the new record in the media 22. After block 114, the method 100 proceeds to block 124.

At block 124, the controller 14 generates an updated environmental map based at least in part on the road configuration indicated by the information about the traffic control device and an existing environmental map. In the scope of the present disclosure, the existing environmental map is an environmental map generated based on perception data (e.g., camera and/or LIDAR data) received using the one or more sensors 16 and/or navigation map data (e.g., GNSS data). The existing environmental map is modified based on the road configuration indicated by the information about the traffic control device to generate the updated environmental map. Therefore, the updated environmental map includes information about road configurations in the environment 28 surrounding the vehicle 12, and more particularly, the updated environmental map includes information about the road configuration indicated by the information about the traffic control device. Therefore, using the system 10 and method 100, the existing environmental map is updated to account for the information provided by traffic control devices in the environment 28.

In an exemplary embodiment, to generate the updated environmental map, the controller 14 determines one or more discrepancies between the existing environmental map and the road configuration indicated by the information about the traffic control device. The controller 14 then determines one or more modifications to the existing environmental map based at least in part on the one or more discrepancies and the road configuration indicated by the information about the traffic control device using a rule-based algorithm. In a non-limiting example, the rule-based algorithm performs pre-programmed modifications to the existing environmental map based on the machine-readable road configuration provided by the machine learning model. The controller 14 then modifies the existing environmental map based at least in part on the one or more modifications to generate the updated environmental map

For example, if the road configuration indicated by the information about the traffic control device indicates that the number three lane ends in four hundred meters, but the existing environmental map includes the number three lane continuing for over four hundred meters, the existing environmental map is modified to remove the number three lane after four hundred meters. The modified existing environmental map is referred to as the updated environmental map. In an exemplary embodiment, the updated environmental map is stored in the media 22 for later use. In another exemplary embodiment, the updated environmental map is also transmitted to one or more remote vehicles and/or server systems using the vehicle communication system 30 for storage, aggregation, and/or distribution. After block 124, the method 100 proceeds to block 126.

At block 126, the controller 14 adjusts the operation of the automated driving system 18 based at least in part on the updated environmental map generated at block 124. In an exemplary embodiment, the adjust the operation of the automated driving system 18, the controller 14 recalculates a vehicle path using the path planning algorithm of the automated driving system 18 based at least in part on the modifications to the existing environmental map performed at block 124. In a non-limiting example, the controller 14 transmits the updated environmental map generated at block 124 to the automated driving system 18 and the automated driving system 18 recalculates the vehicle path using the updated environmental map. In an exemplary embodiment, controller 14 uses the automated driving system 18 to control the vehicle 12 to drive the vehicle 12 along the vehicle path. After block 126, the method 100 proceeds to enter the standby state at block 116.

In an exemplary embodiment, the controller 14 repeatedly exits the standby state 116 and restarts the method 100 at block 102. In a non-limiting example, the controller 14 exits the standby state 116 and restarts the method 100 on a timer, for example, every three hundred milliseconds.

With continued reference to FIG. 2, in a non-limiting example, the controller 14 is configured with a set of computer-executable instructions (i.e., a computer program) to execute the method 100. The set of computer-executable instructions may be organized into a software architecture. The software architecture includes multiple software modules. In the scope of the present disclosure, software modules represent independent software components which are capable of receiving input data, performing operations on the input data according to computer-executable instructions, storing intermediate values (i.e., variables) and/or persisting data (i.e., with non-transitory memory), and providing output data.

In a non-limiting example, the software modules are programmatically implemented as functions, methods, subprograms, subroutines, and/or the like. In an exemplary embodiment, one or more of the software modules is configured to run in a non-blocking manner, meaning that failure or suspension of any one software module does not cause failure or suspension of any other software module. In a non-limiting example, one or more of the software modules are executed concurrently on separate threads of the controller 14. In another non-limiting example, one or more of the software modules are executed on separate controllers distributed throughout the vehicle 12.

In an exemplary embodiment, the software architecture includes a memory governor module 202, a machine learning model governor module 204, a machine learning model execution module 206, and an environmental map updater module 208. In a non-limiting example, the memory governor module 202 is responsible for determining the novelty and relevancy of traffic control devices and tracking previously observed traffic control devices to prevent duplicate recognition/interpretation. The memory governor module 202 executes blocks 106, 108, 110, and 112 of the method 100.

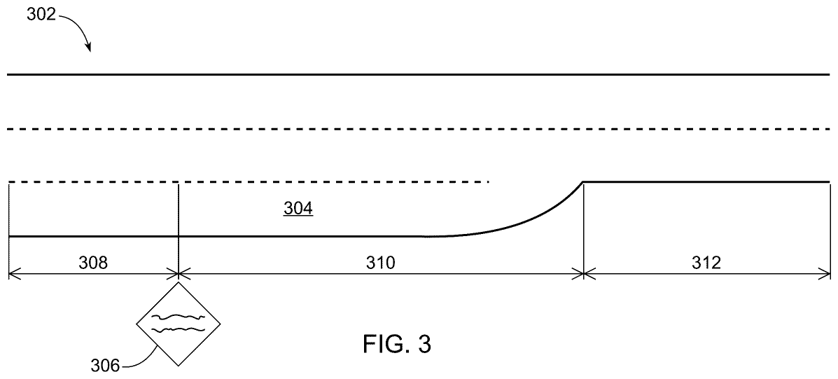

Referring to FIG. 3, a schematic diagram of an exemplary roadway 302 for illustrating the functioning of the memory governor module 202 is shown. The exemplary roadway 302 includes a terminating lane 304 and an exemplary traffic sign 306. In a non-limiting example, the exemplary traffic sign 306 includes text and/or images indicating that the terminating lane 304 is ending. While the vehicle 12 is in a first region 308, the one or more sensors 16 may repeatedly detect the exemplary traffic sign 306, as discussed above in reference to block 106 of the method 100. Therefore, the memory governor module 202 saves information about the exemplary traffic sign 306 in the media 22 and prevents redundant processing of the exemplary traffic sign 306.

While the vehicle 12 is in a second region 310, the memory governor module 202 tracks the location of the vehicle 12 relative to the location of the road configuration indicated by the exemplary traffic sign 306 and determines the relevancy status of the exemplary traffic sign 306 as discussed above in reference to block 108 of the method 100. In an exemplary embodiment, the memory governor module 202 first determines a distance between the exemplary traffic sign 306 and the location of the road configuration indicated by the exemplary traffic sign 306 (e.g., based on road rules or regulations). The memory governor module 202 then uses dead reckoning to track the location of the vehicle 12 relative to the location of the exemplary traffic sign 306. The memory governor module 202 then determines the location of the vehicle 12 relative to the location of the road configuration indicated by the exemplary traffic sign 306.

Thus, by tracking the exemplary traffic sign 306 using dead reckoning, the memory governor module 202 “remembers” the exemplary traffic sign 306 even though it is no longer detected by the one or more sensors 16. As the vehicle 12 crosses into a third region 312, the memory governor module 202 determines that the exemplary traffic sign 306 is no longer relevant and removes or deactivates the corresponding record in the media 22 as discussed above in reference to block 112 of the method 100. It should be understood that the scenario discussed above with reference to FIG. 3 is merely exemplary in nature.

Referring again to FIG. 2, in a non-limiting example, the machine learning model governor module 204 is responsible for reducing calls to the machine learning model execution module 206 by maintaining a knowledgebase about the meaning of (i.e., road configuration indicated by) various examples of traffic control devices. The machine learning model governor module 204 executes blocks 114, 118, and 122 of the method 100.

In a non-limiting example, to interpret a traffic control device, the machine learning model governor module 204 checks the media 22 (or a separate physical or virtual memory) for records of similar traffic control devices as discussed above in reference to block 118. In a non-limiting example, to check the media 22, the machine learning model governor module 204 compares an embedding of the traffic control device to embeddings of previously encountered traffic control devices stored in the media 22. In a non-limiting example, a multimodal text and image encoder is used to generate the embeddings. In a non-limiting example, the embeddings are compared using a cosine measure.

If a similar record is identified, the machine learning model governor module 204 retrieves the similar record instead of executing the machine learning model execution module 206. If a similar record is not already stored in the media 22, the machine learning model governor module 204 uses the machine learning model execution module 206 to determine the road configuration indicated by the traffic control device. The machine learning model governor module 204 then saves the information determined by the machine learning model execution module 206 in the media 22 for later retrieval.

In an exemplary embodiment, the memory governor module 202 and the machine learning model governor module 204 use separate memories (i.e., a separate physical memory device and/or a separate virtual memory container, such as a partition). The memory of the memory governor module 202 acts as a “short-term memory” for the purpose of tracking recently encountered traffic control devices and assessing relevancy. The memory of the machine learning governor module 204 acts as a “long-term memory” for the purpose of maintaining the knowledgebase about the meaning of (i.e., road configuration indicated by) various examples of traffic control devices.

In a non-limiting example, the machine learning model execution module 206 is responsible for executing the machine learning model (e.g., the LLM) as discussed above in reference to the method 100. For example, the machine learning model execution module 206 is responsible for prompting the machine learning model with input information, receiving and parsing output from the machine learning model, and providing the output to the machine learning model governor module 204. The machine learning model execution module 206 may be implemented using the controller 14, an integrated or external graphics processing unit (GPU), another dedicated module, controller, or computer of the vehicle 12, and/or an external device or server. The machine learning model execution module 206 executes block 120 of the method 100.

In a non-limiting example, the environmental map updater module 208 is responsible for updating the existing environmental map based on information from the machine learning model execution module 206 and/or the machine learning model governor module 204. The environmental map updater module 208 executes block 124 of the method 100. It should be understood that the software architecture discussed above, including the configuration and purpose of the modules and the steps of the method 100 executed by each module, is merely exemplary in nature, and that various additional and/or alternative software architectures may be utilized to implement the method 100 within the scope of the present disclosure.

The system 10 and method 100 of the present disclosure offer several advantages. Using the memory governor module 202 and associated steps of the method 100, repeated processing of the same traffic control device is mitigated and each traffic control device is directly associated with corresponding road configurations. Using the machine learning model governor module 204 and associated steps of the method 100, a knowledgebase about the meaning of (i.e., road configuration indicated by) various examples of traffic control devices is maintained, resulting in reduced frequency of calls to the machine learning model execution module 206, thus increasing efficiency and speed. Furthermore, the environmental map updater module 208 and associated steps of the method 100 allow for updating of environmental maps to utilize the information provided using traffic control devices to increase the accuracy of the environmental map and thus the performance of the automated driving system 18.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method for adjusting operation of a vehicle based on traffic control devices, the method comprising:
receiving information about a traffic control device in an environment surrounding the vehicle;
determining a relevancy status of the traffic control device based at least in part on the information about the traffic control device, wherein the relevancy status includes one of a relevant status and an irrelevant status;
determining a road configuration indicated by the information about the traffic control device in response to determining that the relevancy status is the relevant status;
generating an updated environmental map based at least in part on the road configuration indicated by the information about the traffic control device and an existing environmental map, wherein the updated environmental map includes information about road configurations in the environment surrounding the vehicle; and
adjusting an operation of an automated driving system of the vehicle based at least in part on the updated environmental map.

2. The method of claim 1, wherein determining the relevancy status of the traffic control device further comprises:
determining a novelty status of the traffic control device, wherein the novelty status includes one of a novel status and a non-novel status;
determining the relevancy status of the traffic control device to be the relevant status in response to determining that the novelty status of the traffic control device is the novel status; and
determining the relevancy status of the traffic control device based at least in part on a location of the vehicle relative to the traffic control device in response to determining that the novelty status of the traffic control device is the non-novel status.

3. The method of claim 2, wherein determining the novelty status of the traffic control device further comprises:
querying a non-transitory memory of a controller of the vehicle for a matching record corresponding to the traffic control device based at least in part on the information about the traffic control device and a location of the traffic control device;
determining the novelty status of the traffic control device to be the non-novel status in response to determining that the non-transitory memory does include the matching record corresponding to the traffic control device; and
determining the novelty status of the traffic control device to be the novel status in response to determining that the non-transitory memory does not include the matching record corresponding to the traffic control device.

4. The method of claim 2, wherein determining the relevancy status of the traffic control device further comprises:
determining a location of the road configuration indicated by the information about the traffic control device based at least in part on a road regulation;
determining a location of the vehicle relative to the location of the road configuration indicated by the information about the traffic control device;
determining the relevancy status of the traffic control device to be the irrelevant status in response to determining that a distance between the location of the vehicle and the location of the road configuration indicated by the information about the traffic control device is increasing over time; and
determining the relevancy status of the traffic control device to be the relevant status in response to determining that the distance between the location of the vehicle and the location of the road configuration indicated by the information about the traffic control device is decreasing over time.

5. The method of claim 1, wherein determining the road configuration indicated by the information about the traffic control device further comprises:
querying a non-transitory memory of a controller of the vehicle for a similar record based at least in part on the information about the traffic control device, wherein the similar record includes information which is similar to the information about the traffic control device;
retrieving the road configuration indicated by the information about the traffic control device from the non-transitory memory in response to determining that the non-transitory memory does include the similar record; and
determining the road configuration indicated by the information about the traffic control device using a machine learning model based at least in part on the information about the traffic control device in response to determining that the non-transitory memory does not include the similar record.

6. The method of claim 5, wherein determining the road configuration indicated by the information about the traffic control device using a machine learning model further comprises:
determining the road configuration indicated by the information about the traffic control device using a machine learning model based at least in part on the information about the traffic control device, wherein the machine learning model is a large language model (LLM).

7. The method of claim 5, wherein querying the non-transitory memory for the similar record further comprises:
determining a similarity score between the information about the traffic control device and information in each of a plurality of records in the non-transitory memory; and
identifying the similar record of the plurality of records in response to determining that the similarity score between the information about the traffic control device and information in the similar record is greater than or equal to a predetermined similarity threshold.

8. The method of claim 1, wherein generating the updated environmental map further comprises:
determining one or more discrepancies between the existing environmental map and the road configuration indicated by the information about the traffic control device;
determining one or more modifications to the existing environmental map based at least in part on the one or more discrepancies and the road configuration indicated by the information about the traffic control device; and
modifying the existing environmental map based at least in part on the one or more modifications to generate the updated environmental map.

9. The method of claim 8, wherein determining one or more modifications to the existing environmental map further comprises:
determining the one or more modifications to the existing environmental map using a rule-based algorithm based at least in part on the one or more discrepancies and the road configuration indicated by the information about the traffic control device.

10. The method of claim 1, wherein receiving information about the traffic control device in the environment surrounding the vehicle further comprises:
capturing an image of the traffic control device, wherein the traffic control device includes a traffic sign.

11. A system for adjusting operation of a vehicle based on traffic signs, the system comprising:
a camera;
an automated driving system; and
a controller in electrical communication with the camera and the automated driving system, wherein the controller is programmed to:
capture an image of a traffic sign in an environment surrounding the vehicle using the camera;
determine a relevancy status of the traffic sign based at least in part on the image of the traffic sign, wherein the relevancy status includes one of a relevant status and an irrelevant status;
determine a road configuration indicated by the image of the traffic sign in response to determining that the relevancy status is the relevant status;
generate an updated environmental map based at least in part on the road configuration indicated by the image of the traffic sign and an existing environmental map, wherein the updated environmental map includes information about road configurations in the environment surrounding the vehicle; and
adjust an operation of the automated driving system based at least in part on the updated environmental map.

12. The system of claim 11, wherein to determine the relevancy status of the traffic sign, the controller is further programmed to:
determine a novelty status of the traffic sign, wherein the novelty status includes one of a novel status and a non-novel status;
determine the relevancy status of the traffic sign to be the relevant status in response to determining that the novelty status of the traffic sign is the novel status; and
determine the relevancy status of the traffic sign based at least in part on a location of the vehicle relative to the road configuration indicated by the image of the traffic sign in response to determining that the novelty status of the traffic sign is the non-novel status.

13. The system of claim 12, wherein to determine the novelty status of the traffic sign, the controller is further programmed to:
query a non-transitory memory of the controller for a matching record corresponding to the traffic sign based at least in part on the image of the traffic sign and a location of the traffic sign;
determine the novelty status of the traffic sign to be the non-novel status in response to determining that the non-transitory memory does include the matching record corresponding to the traffic sign;
determine the novelty status of the traffic sign to be the novel status in response to determining that the non-transitory memory does not include the matching record corresponding to the traffic sign; and
save a new record for the traffic sign in the non-transitory memory in response to determining that the novelty status of the traffic sign is the novel status.

14. The system of claim 13, wherein to determine the relevancy status of the traffic sign, the controller is further programmed to:
determine a location of the road configuration indicated by the image of the traffic sign based at least in part on a road regulation;
determine a location of the vehicle relative to the location of the road configuration indicated by the image of the traffic sign;
determine the relevancy status of the traffic sign to be the irrelevant status in response to determining that a distance between the location of the vehicle and the location of the road configuration indicated by the image of the traffic sign is increasing over time;
determine the relevancy status of the traffic sign to be the relevant status in response to determining that the distance between the location of the vehicle and the location of the road configuration indicated by the image of the traffic sign is decreasing over time; and
query the non-transitory memory of the controller for a matching record corresponding to the traffic sign based at least in part on the image of the traffic sign and a location of the traffic sign; and
delete the matching record corresponding to the traffic sign from the non-transitory memory in response to determining the relevancy status of the traffic sign to be the irrelevant status.

15. The system of claim 11, wherein to determine the road configuration indicated by the image of the traffic sign, the controller is further programmed to:
query a non-transitory memory of the controller for a similar record based at least in part on the image of the traffic sign, wherein the similar record includes information which is similar to the image of the traffic sign;
retrieve the road configuration indicated by the image of the traffic sign from the non-transitory memory in response to determining that the non-transitory memory does include the similar record;
determine the road configuration indicated by the image of the traffic sign using a large language model (LLM) machine learning model based at least in part on the image of the traffic sign in response to determining that the non-transitory memory does not include the similar record; and
save a new record for the traffic sign in the non-transitory memory in response to determining the road configuration indicated by the image of the traffic sign using the machine learning model.

16. The system of claim 11, wherein to generate the updated environmental map, the controller is further programmed to:
determine one or more discrepancies between the existing environmental map and the road configuration indicated by the image of the traffic sign;
determine one or more modifications to the existing environmental map using a rule-based algorithm based at least in part on the one or more discrepancies and the road configuration indicated by the image of the traffic sign; and
modify the existing environmental map based at least in part on the one or more modifications to generate the updated environmental map.

17. The system of claim 16, wherein to adjust the operation of the automated driving system, the controller is further programmed to:
recalculate a vehicle path using a path planning algorithm of the automated driving system based at least in part on the modifications to the existing environmental map; and
control the vehicle to drive the vehicle along the vehicle path using the automated driving system.

18. A method for adjusting operation of a vehicle based on traffic control devices, the method comprising:
receiving information about a traffic sign in an environment surrounding the vehicle;
determining a novelty status of the traffic sign, wherein the novelty status includes one of a novel status and a non-novel status;
determining a relevancy status of the traffic sign to be a relevant status in response to determining that the novelty status of the traffic sign is the novel status;
determining the relevancy status of the traffic sign based at least in part on a location of the vehicle relative to the traffic sign in response to determining that the novelty status of the traffic sign is the non-novel status;
determining a road configuration indicated by the information about the traffic sign in response to determining that the relevancy status is the relevant status;
generating an updated environmental map based at least in part on the road configuration indicated by the information about the traffic sign and an existing environmental map, wherein the updated environmental map includes information about road configurations in the environment surrounding the vehicle; and
adjusting an operation of an automated driving system of the vehicle based at least in part on the updated environmental map.

19. The method of claim 18, wherein determining the road configuration indicated by the information about the traffic sign further comprises:
querying a non-transitory memory of a controller of the vehicle for a similar record based at least in part on the information about the traffic sign, wherein the similar record includes information which is similar to the information about the traffic sign;
retrieving the road configuration indicated by the information about the traffic sign from the non-transitory memory in response to determining that the non-transitory memory does include the similar record; and
determining the road configuration indicated by the information about the traffic sign using a large language model (LLM) machine learning model based at least in part on the information about the traffic sign in response to determining that the non-transitory memory does not include the similar record.

20. The method of claim 19, wherein querying the non-transitory memory for the similar record further comprises:
determining a similarity score between the information about the traffic sign and information in each of a plurality of records in the non-transitory memory; and
identifying the similar record of the plurality of records in response to determining that the similarity score between the information about the traffic sign and information in the similar record is greater than or equal to a predetermined similarity threshold.
